(19) United States
(12) Patent Application Publication
(10) Pub. No.: US 2020/0209677 A1
(43) Pub. Date: Jul. 2, 2020

(54) MANUFACTURING METHOD OF LIQUID CRYSTAL DISPLAY PANEL, LIQUID CRYSTAL DISPLAY PANEL, AND ELECTRONIC EQUIPMENT

(71) Applicant: Wuhan CHINA STAR OPTOELECTRONICS TECHNOLOGY CO., LTD., Wuhan, Hubei (CN)

(72) Inventor: Bingkun YIN, Wuhan Hubei (CN)

(21) Appl. No.: 16/341,904

(22) PCT Filed: Dec. 29, 2018
(86) PCT No.: PCT/CN2018/125209

§ 371 Date: Apr. 14, 2019

(51) Int. Cl. G02F 1/1335; G02F 1/1337

(52) U.S. Cl. CPC G02F 1/133514; G02F 2202/025; G02F 1/133788

(57) ABSTRACT

A manufacturing method of a liquid crystal display panel, a liquid crystal display panel, and an electronic equipment are provided. The method includes: providing a color filter and a thin film transistor substrate; coating a frame sealant on an edge of a surface of the color filter; providing liquid crystals with ultraviolet curable polymers onto the thin film transistor substrate; and irradiating the color filter and the thin film transistor substrate with ultraviolet rays to photo-cure the frame sealant by the ultraviolet rays, and forming a polymer wall between the frame sealant and the liquid crystals.

### FIELD OF DISCLOSURE

The present disclosure relates to the field of display technologies, and in particular, to a manufacturing method of a liquid crystal display panel, a liquid crystal display panel, and an electronic equipment.

### BACKGROUND

Sealant material is widely used as a bonding and sealing material in a thin film transistor liquid crystal display (TFT-LCD) because of its good adhesion and barrier properties. Since the frame sealant usually needs to be cured by two processes, including ultraviolet ray (UV) irradiation and heating, the frame sealant material will directly contact with a liquid crystal material after a liquid crystal box of the TFT-LCD is formed. The contact of an uncured frame sealant with the liquid crystals is liable to cause liquid crystals contamination, especially when uncured frame sealant components are more easily precipitated and dissolved in the liquid crystals during heating, which may decrease quality of the TFT-LCD.

### SUMMARY OF DISCLOSURE

Embodiments of the present disclosure provide a manufacturing method of a liquid crystal display panel, a liquid crystal display panel, and an electronic equipment, which can effectively avoid direct contact between the liquid crystals and the frame sealant, thereby reducing a risk of contamination of liquid crystals by uncured frame sealant components and improving quality of a TFT-LCD.

An embodiment of the present disclosure provides a manufacturing method of a liquid crystal display panel, including:

providing a color filter and a thin film transistor substrate;

coating a frame sealant on an edge of a surface of the color filter;

providing liquid crystals with ultraviolet curable polymers onto the thin film transistor substrate; and

irradiating the color filter and the thin film transistor substrate with ultraviolet rays to photo-cure the frame sealant by the ultraviolet rays, and forming a polymer wall between the frame sealant and the liquid crystals.

In the manufacturing method of the liquid crystal display panel of the embodiment of the present disclosure, in steps of irradiating the color filter and the thin film transistor substrate with ultraviolet rays to photo-cure the frame sealant by the ultraviolet rays, and forming a polymer wall between the frame sealant and the liquid crystals, includes:

assembling and adhering the color filter with the thin film transistor substrate;

shielding a portion of the liquid crystals by an ultraviolet mask to form a shielding region, and exposing another portion adjacent to a periphery of the shielding region of the liquid crystals to form an unshielding region, where the unshielding region is located between the shielding region and the frame sealant;

irradiating the color filter with the ultraviolet rays to photo-cure the frame sealant by the ultraviolet rays; and

irradiating the thin film transistor substrate with the ultraviolet rays to form the polymer wall at the unshielding region.

In the manufacturing method of the liquid crystal display panel of the embodiment of the present disclosure, in a step of irradiating the thin film transistor substrate with the ultraviolet rays to form the polymer wall at the unshielding region, includes:

irradiating the thin film transistor substrate with the ultraviolet rays through the color filter; and

polymerizing the ultraviolet curable polymers at the unshielding region of the liquid crystals under irradiation of the ultraviolet rays to form the polymer wall at the unshielding region.

In the manufacturing method of the liquid crystal display panel of the embodiment of the present disclosure, before coating a frame sealant on an edge of a surface of the color filter, the manufacturing method further includes:

coating alignment films on corresponding surfaces of the color filter and the thin film transistor substrate, and performing an alignment treatment on the alignment films.

In the manufacturing method of the liquid crystal display panel of the embodiment of the present disclosure, in a step of performing an alignment treatment on the alignment films, includes:

curing the alignment films by heating, and performing the alignment treatment by rubbing or light irradiation.

In the manufacturing method of the liquid crystal display panel of the embodiment of the present disclosure, the manufacturing method further includes: thermally curing the frame sealant.

Another embodiment of the present disclosure also provides a liquid crystal display panel, including: a color filter and a thin film transistor substrate opposite to the color filter, where an edge of a surface of the color filter is provided with a frame sealant; and

liquid crystals are disposed on the thin film transistor substrate, and a polymer wall is formed on a periphery of the liquid crystals, and the polymer wall is located between the frame sealant and the liquid crystals.

In the liquid crystal display panel of the embodiment of the present disclosure, the liquid crystal display panel further includes an ultraviolet mask, where a portion of the liquid crystals is shielded by the ultraviolet mask to form a shielding region, and another portion adjacent to the periphery of the shielding region of the liquid crystals is exposed to form an unshielding region, and the unshielding region is located between the shielding region and the frame sealant; and

where ultraviolet curable polymers are added to the liquid crystals, and the polymer wall is formed on the unshielding region by irradiating the thin film transistor substrate with ultraviolet rays.

In the liquid crystal display panel of the embodiment of the present disclosure, in response to the thin film transistor substrate is irradiated with the ultraviolet rays, the ultraviolet rays are irradiated onto the thin film transistor substrate through the color filter, and the ultraviolet curable polymers at the unshielding region of the liquid crystals under irradiation of the ultraviolet rays are polymerized to form the polymer wall at the unshielding region.

In the liquid crystal display panel of the embodiment of the present disclosure, the ultraviolet rays are irradiated onto the unshielding region of the liquid crystals through the color filter such that the ultraviolet curable polymers in the liquid crystals diffuse toward the unshielding region, and the ultraviolet curable polymers at the unshielding region under irradiation of the ultraviolet rays are polymerized to form the polymer wall at the unshielding region.

In the liquid crystal display panel of the embodiment of the present disclosure, the liquid crystal display panel further includes a display area, where the display area corresponds to the shielding region of the liquid crystals, and is configured to display an image.

In the liquid crystal display panel of the embodiment of the present disclosure, the liquid crystal display panel further includes an alignment film, where the alignment film is disposed between the color filter and the thin film transistor substrate, and the alignment film is configured to control alignment of liquid crystal molecules in the liquid crystals such that the liquid crystal molecules in the liquid crystals are arranged in a specific direction.

In the liquid crystal display panel of the embodiment of the present disclosure, the alignment film is cured by heating and is made by performing an alignment treatment by rubbing or light irradiation.

In the liquid crystal display panel of the embodiment of the present disclosure, the frame sealant is photo-cured by irradiation of the ultraviolet rays, and is thermally cured by heating.

In the liquid crystal display panel of the embodiment of the present disclosure, the frame sealant encapsulates the liquid crystals with the polymer wall between the color filter and the thin film transistor substrate.

Another embodiment of the present disclosure also provides an electronic equipment, including: a case and a liquid crystal display panel, where the liquid crystal display panel is mounted on the case, the liquid crystal display panel includes a color filter and a thin film transistor substrate opposite to the color filter;

where an edge of a surface of the color filter is provided with a frame sealant; and

liquid crystals are disposed on the thin film transistor substrate, and a polymer wall is formed on a periphery of the liquid crystals, and the polymer wall is located between the frame sealant and the liquid crystals.

In the electronic equipment of the embodiment of the present disclosure, the liquid crystal display panel further includes an ultraviolet mask, where a portion of the liquid crystals is shielded by the ultraviolet mask to form a shielding region, and another portion adjacent to the periphery of the shielding region of the liquid crystals is exposed to form an unshielding region, and the unshielding region is located between the shielding region and the frame sealant; and

where ultraviolet curable polymers are added to the liquid crystals, and the polymer wall are formed on the unshielding region by irradiating the thin film transistor substrate with ultraviolet rays.

In the electronic equipment of the embodiment of the present disclosure, in response to the thin film transistor substrate is irradiated with the ultraviolet rays, the ultraviolet rays are irradiated onto the thin film transistor substrate through the color filter, and the ultraviolet curable polymers at the unshielding region of the liquid crystals under irradiation of the ultraviolet rays are polymerized to form the polymer wall at the unshielding region.

In the electronic equipment of the embodiment of the present disclosure, the ultraviolet rays are irradiated onto the unshielding region of the liquid crystals through the color filter such that the ultraviolet curable polymers in the liquid crystals diffuse toward the unshielding region, and the ultraviolet curable polymers at the unshielding region under irradiation of the ultraviolet rays are polymerized to form the polymer wall at the unshielding region.

In the electronic equipment of the embodiment of the present disclosure, the liquid crystal display panel further includes an alignment film, and the alignment film is disposed between the color filter and the thin film transistor substrate, and the alignment film is configured to control alignment of liquid crystal molecules in the liquid crystals such that the liquid crystal molecules in the liquid crystals are arranged in a specific direction.

One embodiment of the present disclosure provides a manufacturing method of a liquid crystal display panel, including providing a color filter and a thin film transistor substrate; coating a frame sealant on an edge of a surface of the color filter; providing liquid crystals with ultraviolet curable polymers onto the thin film transistor substrate; and irradiating the color filter and the thin film transistor substrate with ultraviolet rays to photo-cure the frame sealant by the ultraviolet rays, and forming a polymer wall between the frame sealant and the liquid crystals. The embodiment of the present disclosure forms a polymer wall between the frame sealant and the liquid crystals by photo-curing the frame sealant with the ultraviolet rays, so that the liquid crystals are not in direct contact with the frame sealant, and the risk of contamination of the liquid crystals by uncured frame sealant components during thermal curing the frame sealant or reliability test is reduced, thereby increasing quality of a TFT-LCD.

### BRIEF DESCRIPTION OF DRAWINGS

In order to more clearly describe the technical solutions of the embodiments of the present disclosure, accompanying drawings to be used in the detailed description of the disclosure will be briefly described hereinbelow. Obviously, the accompanying drawings described hereinbelow only illustrate some of the embodiments of the present disclosure, and those of ordinary skill in the art can also obtain other accompanying drawings therefrom without the need of making inventive efforts.

FIG. 1 is a schematic structural diagram of an electronic equipment according to an embodiment of the present disclosure.

FIG. 2 is a schematic structural diagram of a liquid crystal display panel according to an embodiment of the present disclosure.

FIG. 3 is another schematic structural diagram of a liquid crystal display panel according to an embodiment of the present disclosure.

FIG. 4 is another schematic structural diagram of a liquid crystal display panel according to an embodiment of the present disclosure.

FIG. 5 is a schematic structural diagram of an ultraviolet mask according to an embodiment of the present disclosure.

FIG. 6 is another schematic structural diagram of a liquid crystal display panel according to an embodiment of the present disclosure.

FIG. 7 is another schematic structural diagram of a liquid crystal display panel according to an embodiment of the present disclosure.

FIG. 8 is a flowchart of a manufacturing method of a liquid crystal display panel according to an embodiment of the present disclosure.

FIG. 9 is another flowchart of a manufacturing method of a liquid crystal display panel according to an embodiment of the present disclosure.

### DETAILED DESCRIPTION

The following clearly describes the technical solutions in the embodiments of the present disclosure with reference to the accompanying drawings in the embodiments of the present disclosure. The described embodiments are merely a part rather than all of the embodiments of the present disclosure. All other embodiments obtained by a person of ordinary skill in the art based on the embodiments of the present disclosure without creative efforts shall fall within the protection scope of the present disclosure.

In the description of the present disclosure, it should be understood that the terms “central”, “longitudinal”, “transversal”, “length”, “width”, “thicknes s”, “upper”, “lower”, “front”, “rear”, “left”, “right”, “vertical”, “horizontal”, “top”, “bottom”, “inner”, “outer”, “clockwise”, “counterclockwise” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure. In addition, terms of “first”, “second” are only used for description, but shall not be understood as indication or implication of relative importance or implicit indication of the number of the specific technical features. Therefore, the features defined by the terms “first” and “second” may explicitly or implicitly include one or more of these features. In the description of the present disclosure, the term “more” or “a plurality of” signifies at least two, unless otherwise specified.

In the present disclosure, except where specifically otherwise illustrated or limited, the terms “install”, “connect”, “link” and “fix” used herein should be understood in a broad sense. Such as, the meaning may be fixedly connection, removable connection, or integrated connection. The meaning may also be mechanical connection, electrical connection, direct connection or indirect connection through intermediaries, or internal connection within two elements. The meaning of the terms used herein may be understood by one of ordinary skill in the related art according to specific conditions of the present disclosure.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Various embodiments and examples are provided in the following description to implement different structures of the present disclosure. In order to simplify the present disclosure, certain elements and settings will be described. However, these elements and settings are only by way of example and are not intended to limit the present disclosure. In addition, reference numerals may be repeated in different examples in the present disclosure. This repeating is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

Embodiments of the present disclosure provide a manufacturing method of a liquid crystal display panel, a liquid crystal display panel, and an electronic equipment. The liquid crystal display panel can be integrated into the electronic equipment, and the liquid crystal display panel can be manufactured by the manufacturing method of the liquid crystal display panel. The electronic equipment can be a smart wearable device, a smart phone, a tablet, a smart TV and other device.

In an existing thin film transistor liquid crystal display (TFT-LCD) process, since the frame sealant usually needs to be cured by two processes, including ultraviolet ray (UV) irradiation and heating, the frame sealant material will directly contact with a liquid crystal material after a liquid crystal box of the TFT-LCD is formed. The contact of an uncured frame sealant with the liquid crystals is liable to cause liquid crystals contamination, especially when uncured frame sealant components are more easily precipitated and dissolved in the liquid crystals during heating, which may decrease quality of the TFT-LCD. The present disclosure provides a liquid crystal display panel, which forms a polymer wall between the frame sealant and the liquid crystals during photo-curing the frame sealant with ultraviolet rays, so that the liquid crystals are not in direct contact with the frame sealant, and the risk of contamination of the liquid crystals by the uncured frame sealant components during thermal curing the frame sealant or reliability test is reduced, thereby increasing quality of the TFT-LCD.

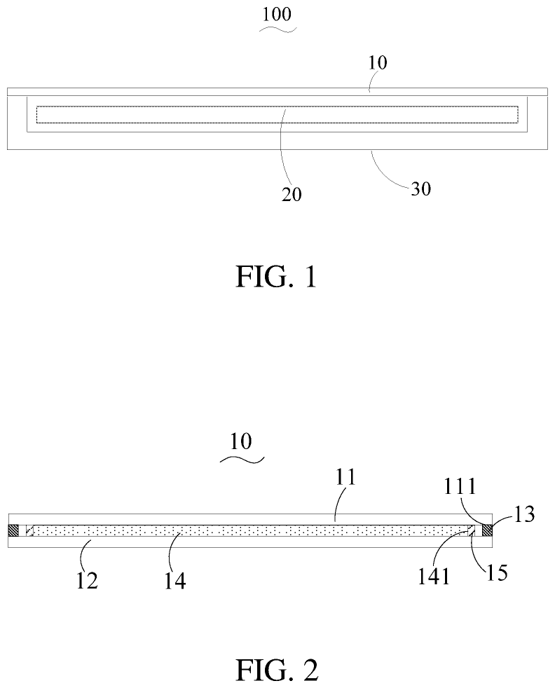

Referring to FIG. 1, which is a schematic structural diagram of an electronic equipment according to an embodiment of the present disclosure. The electronic equipment 100 can include a liquid crystal display panel 10, a control circuit 20, and a case 30. It should be noted that the electronic equipment 100 shown in FIG. 1 is not limited to the above, and may further include other devices, such as a camera, an antenna structure, a pattern unlock module, and the like.

The liquid crystal display panel 10 is set on the case 30.

In some embodiments, the liquid crystal display panel 10 can be secured to the case 30, and the liquid crystal display panel 10 and case 30 form a confined space to accommodate components such as the control circuit 20.

In some embodiments, the case 30 can be made of a flexible material, such as a plastic case or a silicone case.

The control circuit 20 is installed in case 30. The control circuit 20 can be a motherboard of electronic equipment 100. The control circuit 20 can integrate one, two or more of a battery, an antenna structure, a microphone, a speaker, a headphone jack, a universal serial bus interface, a camera, a distance sensor, an ambient light sensor, a receiver, and a processor.

The liquid crystal display panel 10 is installed in the case 30, and the liquid crystal display panel 10 is electrically connected to the control circuit 20 to form a display surface of the electronic equipment 100. The liquid crystal display panel 10 can include a display area and a non-display area. The display area can be used to display the screen of the electronic equipment 100 or for the user to perform touch operation. The non-display area can be used to set various functional components.

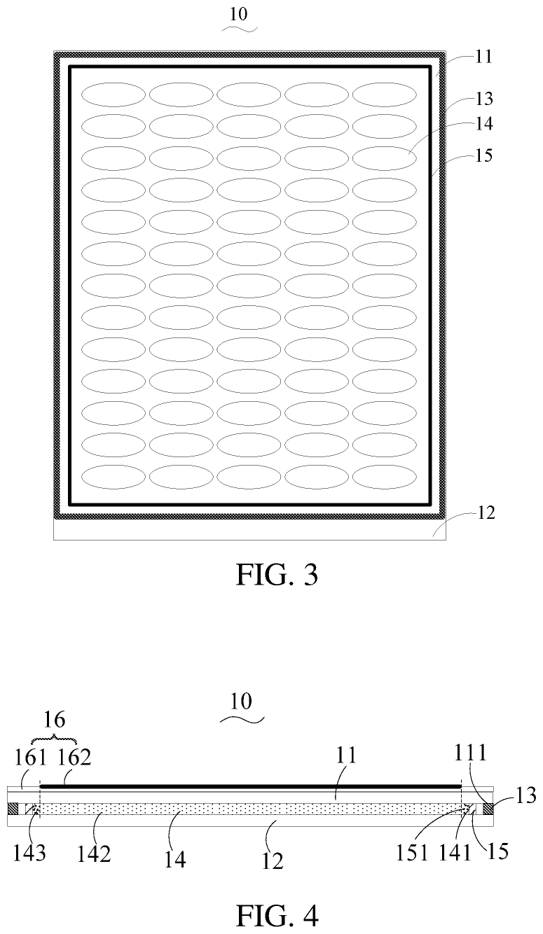

Referring to FIG. 2 and FIG. 3, FIG. 2 and FIG. 3 are schematic structural diagrams of a liquid crystal display panel according to an embodiment of the present disclosure. The liquid crystal display panel 10 may include a color filter 11 and a thin film transistor substrate 12 opposite to the color filter 11.

The color filter (CF) 11 can be attached and assembled to the thin film transistor (TFT) substrate 12.

An edge a surface 111 of the color filter 11 is provided with a frame sealant 13, that is the frame sealant 13 is disposed at the edge of the surface 111 of the color filter 11, and the surface 111 of the color filter 11 is near to one side of the thin film transistor substrate 12.

Liquid crystals 14 are disposed on the thin film transistor substrate 12, and a periphery 141 of the liquid crystals 14 is provided with a polymer wall 15 between the frame sealant 13 and the liquid crystals 14.

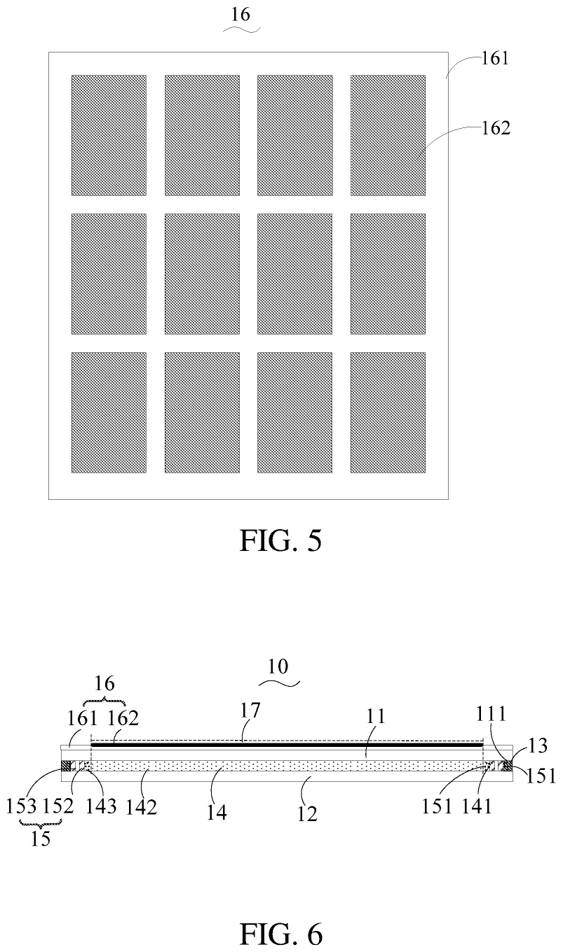

In another embodiment, please refer to FIG. 4 and FIG. 5. FIG. 4 is another schematic structural diagram of a liquid crystal display panel according to an embodiment of the present disclosure, and FIG. 5 is a schematic structural diagram of an ultraviolet mask according to an embodiment of the present disclosure. FIG. 4 is different from FIG. 2 in that the liquid crystal display panel 10 further includes an ultraviolet mask (UV mask) 16.

For example, the ultraviolet mask 16 can be disposed above the color filter 11. For example, a black matrix photoresist material may be disposed on a predetermined position of the color filter 11 to form the ultraviolet mask 16.

For example, the ultraviolet mask 16 can be disposed above the liquid crystals 14.

A portion of the liquid crystals 14 is shielded by the ultraviolet mask 16 to form a shielding region 142, and another portion adjacency to the periphery of the shielding region 142 of the liquid crystals 14 is exposed to form an unshielding region 143. The unshielding region 143 is located between the shielding region 142 and the frame sealant 13.

Ultraviolet curable polymers 151 are added to the liquid crystals 14, and the polymer wall 15 is formed at the unshielding region 143 by irradiating the thin film transistor substrate 12 with ultraviolet rays.

The ultraviolet curable polymers 151 are a polymer component which can be photo-cured by ultraviolet rays. For example, the ultraviolet curable polymers 151 may be an acrylate monomer.

For example, as shown in FIG. 5, the ultraviolet mask 16 may be covered with a black matrix photoresist material at a predetermined position of a glass substrate 161 to form a light shielding layer 162. The glass substrate 161 and the light shielding layer 162 constitute the ultraviolet mask 16. When the ultraviolet rays are irradiated on the ultraviolet mask 16, a partial of ultraviolet rays may be shielded by the light shielding layer 162, and some of the ultraviolet rays may pass through a region other than the light shielding layer 162.

In some embodiments, when ultraviolet rays are irradiated to the thin film transistor substrate 12, the ultraviolet rays are irradiated on the thin film transistor substrate 12 through the color filter 11, and the ultraviolet curable polymers 151 in the liquid crystals 14 at the unshielding region 143 under irradiation of the ultraviolet rays are polymerized to form the polymer wall 15 at the unshielding region 143.

The ultraviolet rays are irradiated onto the unshielding region 143 of the liquid crystals 14 through the color filter 12, so that the ultraviolet curable polymers 151 in the liquid crystals 14 diffuse into the unshielding region 143, and the unshielding region 143 are polymerized under irradiation of ultraviolet rays to form the polymer wall 15 at the unshielding region 143.

In another embodiment, please refer to FIG. 6. FIG. 6 is another schematic structural diagram of a liquid crystal display panel according to an embodiment of the present disclosure. FIG. 6 is different from FIG. 4 in that the polymer wall 15 may include a first polymer wall 152 and a second polymer wall 153.

The ultraviolet curable polymers 151 are added to the frame sealant 13 and the liquid crystals 14, and the first polymer wall 152 and the second polymer wall 153 can be formed at the unshielding region 143 by irradiating the frame sealant 13 and the liquid crystals 14 with the ultraviolet rays. The first polymer wall 152 is formed by irradiating the ultraviolet curable polymers 151 added in the liquid crystals 14 with the ultraviolet rays, and the second polymer wall 153 is formed by irradiating the ultraviolet curable polymers 151 added in the frame sealant 13 with the ultraviolet rays.

The first polymer wall 152 is formed at the periphery of the liquid crystals, and the second polymer wall 153 is formed at an inner side of the frame sealant. The formation position of the first polymer wall 152 and the second polymer wall 153 is controlled by the ultraviolet mask 16. By setting a double layer polymer wall, it is possible to more effectively avoid contact between liquid crystals and frame sealant.

In some embodiments, the liquid crystal display panel 10 further includes a display area 17 corresponding to the shielding region 142 of the liquid crystals 14 to display an image. The liquid crystals corresponding to the display area 17 is shielded by the ultraviolet mask 16 to prevent the liquid crystals at the display area 17 from being affected by the ultraviolet rays.

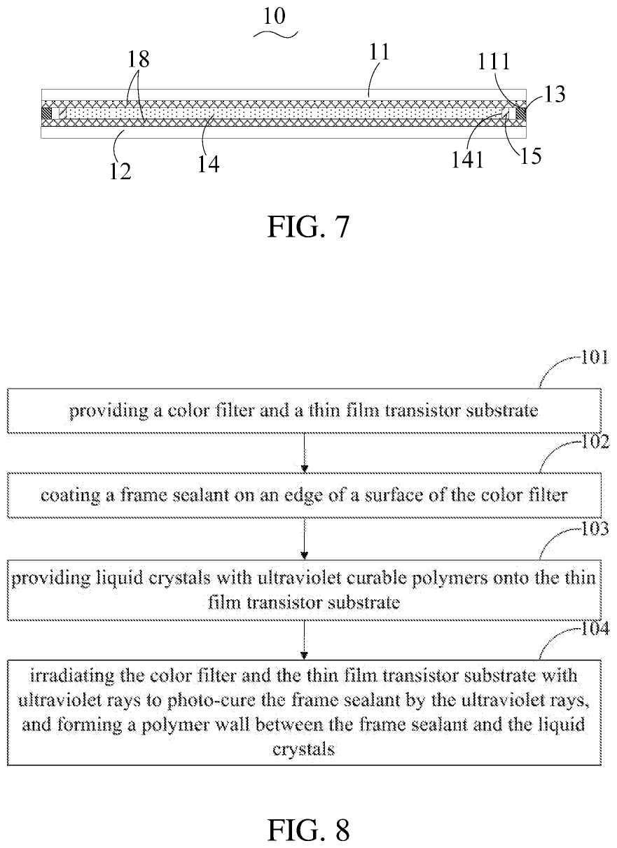

In another embodiment, please refer to FIG. 7. FIG. 7 is another schematic structural diagram of a liquid crystal display panel according to an embodiment of the present disclosure. The difference between FIG. 7 and FIG. 2 is that the liquid crystal display panel 10 further includes alignment films 18 disposed between the color filter 11 and the thin film transistor substrate 12, and the alignment films 18 are used to control alignment of liquid crystal molecules in the liquid crystals 14 such that the liquid crystal molecules in the liquid crystals 14 are arranged in a specific direction

In some embodiments, the alignment films 18 can be cured by heating and are made by performing an alignment treatment by rubbing or light irradiation.

For example, the color filter 11 and the thin film transistor substrate 12 are individually cleaned and dried, and then the alignment films 18 are uniformly printed on surfaces of the color filter 11 and the thin film transistor substrate 12, and then the alignment films 18 are cured by heating and are made by performing the alignment treatment by rubbing or light irradiation.

For example, the alignment treatment is performed by rubbing, so that the surface of the alignment films 18 forms a microgroove structure and has a certain anchoring energy, and has an alignment control force on the liquid crystal molecules. Thus, the liquid crystal molecules form a certain inclination angle and have a correct and stable orientation.

In some embodiments, the frame sealant 13 can be photo-cured by irradiation of the ultraviolet rays, and is thermally cured by heating.

In some embodiments, the frame sealant 13 encapsulates the liquid crystals 14 having the polymer wall 15 between the color filter 11 and the thin film transistor substrate 12.

The liquid crystal display panel provided by the embodiments of the present disclosure includes the color filter 11 and the thin film transistor substrate 12 opposite to the color filter 11, where the edge of the surface 111 of the color filter 11 is provided with the frame sealant 13. The liquid crystals 14 is disposed on the thin film transistor substrate 12, and the periphery 141 of the liquid crystals 14 is provided with the polymer wall 15 between the frame sealant 13 and the liquid crystals 14. In the embodiments of the present disclosure, the polymer wall is formed between the frame sealant and the liquid crystals, so that the liquid crystals are not in direct contact with the frame sealant, and the risk of contamination of the liquid crystals by uncured frame sealant components during thermal curing the frame sealant or reliability test is reduced, thereby increasing quality of the TFT-LCD.

In order to further describe the present disclosure, the following description is made in an aspect of a manufacturing method of a liquid crystal display panel.

Referring to FIG. 8, FIG. 8 is a flowchart of a manufacturing method of a liquid crystal display panel according to an embodiment of the present disclosure. The manufacturing method of the liquid crystal display panel includes:

In a step 101, a color filter and a thin film transistor substrate are provided.

In a step 102, a frame sealant is coated on an edge of a surface of the color filter.

For example, the frame sealant is disposed at the edge of the surface of the color filter, and the surface of the color filter is near to a side of the thin film transistor substrate.

In a step 103, liquid crystals with ultraviolet curable polymers are provided onto the thin film transistor substrate.

In a step 104, the color filter and the thin film transistor substrate are irradiated with ultraviolet rays to photo-cure the frame sealant by the ultraviolet rays, and a polymer wall is formed between the frame sealant and the liquid crystals.

In some embodiments, in steps of irradiating the color filter and the thin film transistor substrate with ultraviolet rays to photo-cure the frame sealant by the ultraviolet rays, and forming a polymer wall between the frame sealant and the liquid crystals, the method includes:

assembling and adhering the color filter with the thin film transistor substrate;

shielding a portion of the liquid crystals by the ultraviolet mask to form a shielding region, and exposing another portion adjacent to a periphery of the shielding region of the liquid crystals to form an unshielding region, where the unshielding region is located between the shielding region and the frame sealant;

irradiating the color filter with the ultraviolet rays to photo-cure the frame sealant by the ultraviolet rays; and

irradiating the thin film transistor substrate with the ultraviolet rays to form the polymer wall at the unshielding region.

In some embodiments, in a step of irradiating the thin film transistor substrate with the ultraviolet rays to form the polymer wall at the unshielding region, the method includes:

irradiating the thin film transistor substrate with the ultraviolet rays through the color filter; and

polymerizing the ultraviolet curable polymers at the unshielding region of the liquid crystals under irradiation of the ultraviolet rays to form the polymer wall at the unshielding region.

In some embodiments, ultraviolet curable polymers may also be added to the frame sealant. A double layer polymer wall may be formed between the frame sealant and the liquid crystals by changing the position of the shielding region and the unshielding region corresponding to the ultraviolet mask.

For example, the ultraviolet curable polymers can be added to both the frame sealant and the liquid crystals, and a first polymer wall and a second polymer wall can be formed at the unshielding region by irradiating the frame sealant and the liquid crystals with the ultraviolet rays. The first polymer wall is formed by irradiating the ultraviolet curable polymers added in the liquid crystals with the ultraviolet rays, and the second polymer wall is formed by irradiating the ultraviolet curable polymers added in the frame sealant with the ultraviolet rays.

The first polymer wall is formed on the periphery of the liquid crystals, and the second polymer wall is formed on an inner side of the frame sealant. The formation position of the first polymer wall and the second polymer wall is controlled by the ultraviolet mask. By setting a double layer polymer wall, it is possible to more effectively avoid contact between liquid crystals and frame sealant.

For example, a polymer component that can be photo-cured is added to the liquid crystals, and the polymer component can form the polymer wall in the liquid crystals where it is irradiated by the ultraviolet when the frame sealant is photo-cured. The ultraviolet mask (UV mask) design can control the formation position of the polymer wall in the liquid crystals, so that the polymer wall is formed on a side of the frame sealant close to the liquid crystals. Thus, the liquid crystals are not in direct contact with the frame sealant, and the risk of contamination of the liquid crystals by the uncured frame sealant components during thermal curing the frame sealant or reliability test is reduced.

The embodiment of the present disclosure provides the manufacturing method of the liquid crystal display panel, including providing the color filter and the thin film transistor substrate; coating the frame sealant on an edge of the surface of the color filter; providing the liquid crystals with the ultraviolet curable polymers onto the thin film transistor substrate; and irradiating the color filter and the thin film transistor substrate with ultraviolet rays to photo-cure the frame sealant by the ultraviolet rays, and forming the polymer wall between the frame sealant and the liquid crystals. The embodiment of the present disclosure forms the polymer wall between the frame sealant and the liquid crystals by photo-curing the frame sealant with the ultraviolet rays, so that the liquid crystals are not in direct contact with the frame sealant, and the risk of contamination of the liquid crystals by the uncured frame sealant components during thermal curing the frame sealant or reliability test is reduced, thereby increasing quality of a TFT-LCD.

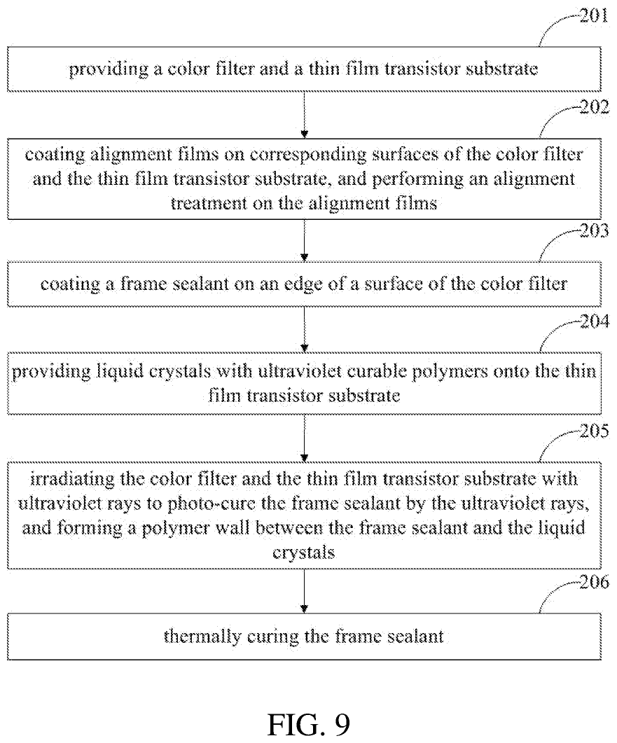

Referring to FIG. 9, FIG. 9 is another flowchart of a manufacturing method of a liquid crystal display panel according to an embodiment of the present application. The manufacturing method of the liquid crystal display panel includes:

In a step 201, a color filter and a thin film transistor substrate are provided.

In a step 202, alignment films are coated on corresponding surfaces of the color filter and the thin film transistor substrate, and an alignment treatment is performed on the alignment films.

In some embodiments, in the step of performing an alignment treatment on the alignment films, the method includes:

curing the alignment films by heating, and performing the alignment treatment by rubbing or light irradiation.

For example, the color filter and the thin film transistor substrate are individually cleaned and dried, and then the alignment films are uniformly printed on surfaces of the color filter and the thin film transistor substrate, and then the alignment films are cured by heating and are made by performing the alignment treatment by rubbing or light irradiation.

For example, the alignment treatment is performed by rubbing, so that the surface of the alignment films forms a microgroove structure and has a certain anchoring energy, and has an alignment control force on the liquid crystal molecules. Thus, the liquid crystal molecules form a certain inclination angle and have a correct and stable orientation.

In a step 203, a frame sealant is coated on an edge of a surface of the color filter.

For example, the frame sealant is disposed at the edge of the surface of the color filter, and the surface of the color filter is near to a side of the thin film transistor substrate.

In a step 204, liquid crystals with ultraviolet curable polymers are provided onto the thin film transistor substrate.

In a step 205, the color filter and the thin film transistor substrate are irradiated with ultraviolet rays to photo-cure the frame sealant by the ultraviolet rays, and a polymer wall is formed between the frame sealant and the liquid crystals.

In some embodiments, in steps of irradiating the color filter and the thin film transistor substrate with ultraviolet rays to photo-cure the frame sealant by the ultraviolet rays, and forming a polymer wall between the frame sealant and the liquid crystals, the method includes:

assembling and adhering the color filter with the thin film transistor substrate;

shielding a portion of the liquid crystals by the ultraviolet mask to form a shielding region, and exposing another portion adjacent to a periphery of the shielding region of the liquid crystals to form an unshielding region, where the unshielding region is located between the shielding region and the frame sealant;

irradiating the color filter with the ultraviolet rays to photo-cure the frame sealant by the ultraviolet rays; and

irradiating the thin film transistor substrate with the ultraviolet rays to form the polymer wall at the unshielding region.

In some embodiments, in a step of irradiating the thin film transistor substrate with the ultraviolet rays to form the polymer wall at the unshielding region, the method includes:

irradiating the thin film transistor substrate with the ultraviolet rays through the color filter; and

polymerizing the ultraviolet curable polymers at the unshielding region of the liquid crystals under irradiation of the ultraviolet rays to form the polymer wall at the unshielding region.

In some embodiments, ultraviolet curable polymers may also be added to the frame sealant. A double layer polymer wall may be formed between the frame sealant and the liquid crystals by changing the position of the shielding region and the unshielding region corresponding to the ultraviolet mask.

For example, the ultraviolet curable polymers can be added to both the frame sealant and the liquid crystals, and a first polymer wall and a second polymer wall can be formed at the unshielding region by irradiating the frame sealant and the liquid crystals with the ultraviolet rays. The first polymer wall is formed by irradiating the ultraviolet curable polymers added in the liquid crystals with the ultraviolet rays, and the second polymer wall is formed by irradiating the ultraviolet curable polymers added in the frame sealant with the ultraviolet rays.

The first polymer wall is formed on the periphery of the liquid crystals, and the second polymer wall is formed on an inner side of the frame sealant. The formation position of the first polymer wall and the second polymer wall is controlled by the ultraviolet mask. By setting a double layer polymer wall, it is possible to more effectively avoid contact between liquid crystals and frame sealant.

In a step 206, the frame sealant is thermal cured.

The embodiment of the present disclosure provides the manufacturing method of the liquid crystal display panel, including providing the color filter and the thin film transistor substrate; coating the alignment films on corresponding surfaces of the color filter and the thin film transistor substrate, and performing the alignment treatment on the alignment films; coating the frame sealant on the edge of the surface of the color filter; providing the liquid crystals with the ultraviolet curable polymers onto the thin film transistor substrate; and irradiating the color filter and the thin film transistor substrate with ultraviolet rays to photo-cure the frame sealant by the ultraviolet rays, and forming the polymer wall between the frame sealant and the liquid crystals. The embodiment of the present disclosure forms the polymer wall between the frame sealant and the liquid crystals by photo-curing the frame sealant with the ultraviolet rays, so that the liquid crystals are not in direct contact with the frame sealant, and a risk of contamination of the liquid crystals by uncured frame sealant components during thermal curing the frame sealant or reliability test is reduced, thereby increasing quality of a TFT-LCD.

The manufacturing method of the liquid crystal display panel, the liquid crystal display panel, and the electronic equipment provided by the present disclosure are described above in detail. Although the principles and implementation manners of the present disclosure are described by using specific embodiments in this context, the foregoing descriptions of the embodiments are only intended to help understanding the method of the present disclosure and core idea thereof. In addition, with regard to the specific implementations and the disclosure scope, modifications may be made by those of ordinary skill in the art according to the idea of the present disclosure. In conclusion, the content of this description shall not be construed as a limitation to the present disclosure.

What is claimed is:

1. A manufacturing method of a liquid crystal display panel, comprising:
providing a color filter and a thin film transistor substrate;
coating a frame sealant on an edge of a surface of the color filter;
providing liquid crystals with ultraviolet curable polymers onto the thin film transistor substrate; and
irradiating the color filter and the thin film transistor substrate with ultraviolet rays to photo-cure the frame sealant by the ultraviolet rays, and forming a polymer wall between the frame sealant and the liquid crystals.

2. The manufacturing method of the liquid crystal display panel as claimed in claim 1, wherein in steps of irradiating the color filter and the thin film transistor substrate with the ultraviolet rays to photo-cure the frame sealant by the ultraviolet rays, and forming the polymer wall between the frame sealant and the liquid crystals, comprises:
assembling and adhering the color filter with the thin film transistor substrate;
shielding a portion of the liquid crystals by an ultraviolet mask to form a shielding region, and exposing another portion adjacent to a periphery of the shielding region of the liquid crystals to form an unshielding region, wherein the unshielding region is located between the shielding region and the frame sealant;
irradiating the color filter with the ultraviolet rays to photo-cure the frame sealant by the ultraviolet rays; and
irradiating the thin film transistor substrate with the ultraviolet rays to form the polymer wall at the unshielding region.

3. The manufacturing method of the liquid crystal display panel as claimed in claim 2, wherein in a step of irradiating the thin film transistor substrate with the ultraviolet rays to form the polymer wall at the unshielding region, comprises:
irradiating the thin film transistor substrate with the ultraviolet rays through the color filter; and
polymerizing the ultraviolet curable polymers at the unshielding region of the liquid crystals under irradiation of the ultraviolet rays to form the polymer wall at the unshielding region.

4. The manufacturing method of the liquid crystal display panel as claimed in claim 1, before coating the frame sealant on the edge of the surface of the color filter, further comprising:
coating alignment films on corresponding surfaces of the color filter and the thin film transistor substrate, and performing an alignment treatment on the alignment films.

5. The manufacturing method of the liquid crystal display panel as claimed in claim 4, in a step of performing the alignment treatment on the alignment films, comprising:
curing the alignment films by heating, and performing the alignment treatment by rubbing or light irradiation.

6. The manufacturing method of the liquid crystal display panel as claimed in claim 1, further comprising: thermally curing the frame sealant.

7. A liquid crystal display panel, comprising: a color filter and a thin film transistor substrate opposite to the color filter, wherein an edge of a surface of the color filter is provided with a frame sealant; and
liquid crystals are disposed on the thin film transistor substrate, and a polymer wall is formed on a periphery of the liquid crystals, and the polymer wall is located between the frame sealant and the liquid crystals.

8. The liquid crystal display panel as claimed in claim 7, further comprising an ultraviolet mask, wherein a portion of the liquid crystals is shielded by the ultraviolet mask to form a shielding region, and another portion adjacent to the periphery of the shielding region of the liquid crystals is exposed to form an unshielding region, and the unshielding region is located between the shielding region and the frame sealant; and
wherein ultraviolet curable polymers are added to the liquid crystals, and the polymer wall is formed on the unshielding region by irradiating the thin film transistor substrate with ultraviolet rays.

9. The liquid crystal display panel as claimed in claim 8, wherein in response to the thin film transistor substrate is irradiated with the ultraviolet rays, the ultraviolet rays are irradiated onto the thin film transistor substrate through the color filter, and the ultraviolet curable polymers at the unshielding region of the liquid crystals under irradiation of the ultraviolet rays are polymerized to form the polymer wall at the unshielding region.

10. The liquid crystal display panel as claimed in claim 9, wherein the ultraviolet rays are irradiated onto the unshielding region of the liquid crystals through the color filter such that the ultraviolet curable polymers in the liquid crystals diffuses toward the unshielding region, and the ultraviolet curable polymers at the unshielding region under irradiation of the ultraviolet rays are polymerized to form the polymer wall at the unshielding region.

11. The liquid crystal display panel as claimed in claim 10, further comprising a display area, wherein the display area corresponds to the shielding region of the liquid crystals, and is configured to display an image.

12. The liquid crystal display panel as claimed in claim 7, further comprising a alignment film, wherein the alignment film is disposed between the color filter and the thin film transistor substrate, and the alignment film is configured to control alignment of liquid crystal molecules in the liquid crystals such that the liquid crystal molecules in the liquid crystals are arranged in a specific direction.

13. The liquid crystal display panel as claimed in claim 12, wherein the alignment film is cured by heating and is made by performing an alignment treatment by rubbing or light irradiation.

14. The liquid crystal display panel as claimed in claim 7, wherein the frame sealant is photo-cured by irradiation of the ultraviolet rays, and is thermally cured by heating.

15. The liquid crystal display panel as claimed in claim 14, wherein the frame sealant encapsulates the liquid crystals with the polymer wall between the color filter and the thin film transistor substrate.

16. An electronic equipment, comprising: a case and a liquid crystal display panel, wherein the liquid crystal display panel is mounted on the case, the liquid crystal display panel comprises a color filter and a thin film transistor substrate opposite to the color filter;
wherein an edge of a surface of the color filter is provided with a frame sealant; and
liquid crystals are disposed on the thin film transistor substrate, and a polymer wall is formed on a periphery of the liquid crystals, and the polymer wall is located between the frame sealant and the liquid crystals.

17. The electronic equipment as claimed in claim 16, wherein the liquid crystal display panel further comprises an ultraviolet mask, wherein a portion of the liquid crystals is shielded by the ultraviolet mask to form a shielding region, and another portion adjacent to the periphery of the shielding region of the liquid crystals is exposed to form an unshielding region, and the unshielding region is located between the shielding region and the frame sealant; and
wherein ultraviolet curable polymers are added to the liquid crystals, and the polymer wall is formed on the unshielding region by irradiating the thin film transistor substrate with ultraviolet rays.

18. The electronic equipment as claimed in claim 17, wherein in response to the thin film transistor substrate is irradiated with the ultraviolet rays, the ultraviolet rays are irradiated onto the thin film transistor substrate through the color filter, and the ultraviolet curable polymers at the unshielding region of the liquid crystals under irradiation of the ultraviolet rays are polymerized to form the polymer wall at the unshielding region.

19. The electronic equipment as claimed in claim 18, wherein the ultraviolet rays are irradiated onto the unshielding region of the liquid crystals through the color filter such that the ultraviolet curable polymers in the liquid crystals diffuses toward the unshielding region, and the ultraviolet curable polymers at the unshielding region under irradiation of the ultraviolet rays are polymerized to form the polymer wall at the unshielding region.

20. The electronic equipment as claimed in claim 16, wherein the liquid crystal display panel further comprises an alignment film, and the alignment film is disposed between the color filter and the thin film transistor substrate, and the alignment film is configured to control alignment of liquid crystal molecules in the liquid crystals such that the liquid crystal molecules in the liquid crystals are arranged in a specific direction.
